(19) United States
(12) Patent Application Publication
(10) Pub. No.: US 2016/0107371 A1
(43) Pub. Date: Apr. 21, 2016

(54) METHOD FOR PRODUCING MICRO- OR NANOSTRUCTURES IN POLYMERIC FILM MATERIALS

(71) Applicant: ISCENT OY, Vantaa (FI)

(72) Inventors: Eero HURME, Espoo (FI); Jaakko RAUKOLA, Tampere (FI); Valtteri KALIMA, Porvoo (FI)

(21) Appl. No.: 14/895,799

(22) PCT Filed: Oct. 3, 2013
(86) PCT No.: PCT/FI2013/050959

§ 371 Date: Dec. 3, 2015

(30) Foreign Application Priority Data
Oct. 5, 2012 (FI) 20126040

(51) Int. Cl. B29C 59/02; B29C 59/04; B29C 43/22

(52) U.S. Cl. CPC B29C 59/022; B29C 43/222; B29C 59/04; B29C 2059/023; B29K 2101/12

(57) ABSTRACT

The invention relates to a method for producing micro- or nanostructures in polymer film materials having thermoforming properties in an extrusion process. The method according to invention comprises providing a molten thermoforming polymer film (1) from an extruder (2), driving a molten polymer film (1) through a nip (3) wherein the molten thermoforming polymer film (1) is contacted with a cooling roller (4) supporting a master film with a surface relief pattern (5) and a pressure roller (6), so that micro- or nanostructures are replicated onto the polymer film by the action of pressure and cooling at the nip. The master film is a polymeric master film it is driven continuously from the master film feed roller (9) through the nip (3) to the receiver roller (10).

### FIELD OF THE INVENTION

The invention relates to a method for producing micro- or nanostructures in polymeric film materials having thermoforming properties, a master film with a surface relief pattern for producing micro- or nanostructures in polymer film materials having thermoforming properties and a use thereof.

### BACKGROUND OF THE INVENTION

Two different basic techniques are used in continuous roll-to-roll manufacturing of macro- or nanostructures, for example diffractive optical elements, on flexible substrates. Hot embossing uses a metallic shim, typically a shim made of nickel, with which a fine structure is pressed into the surface of the heated polymer. Another method of producing diffractive optical elements is UV embossing, where a liquid monomer or polymer placed in a shim is hardened with the aid of ultraviolet light.

Although industrial manufacturing of diffractive optical elements is comparatively simple, their manufacturing requires machines using high nip pressures. The high nip pressures used in the manufacturing process shortens the life time of metallic shims. Another challenge is too narrow web widths required for continuous roll-to-roll mass production of flexible films, which is due to very high demand for mechanical performances of the shim assembly, and nip pressures.

Publication MX2008009758 discloses a method for embossing holograms in plastic films with a metallic nickel shim using a molten polymer during film extrusion, wherein holographic patterns are created on plastic films by 1) feeding the extruding machine with polymer granules, 2) then the molten polymer(s), having a curtain shape resulting from the flat die, are brought into contact with a cooling roller coated with a nickel shim, 3) the embossing of the effect is performed in the film upon being solidified by the cooling effect.

The disadvantage of the method above is that industrial scale extrusion processes require larger metallic shims to be assembled around cooling rollers. Large metallic shims are not available and the manufacturing of large metallic shims by embossing techniques is difficult and very costly.

### PURPOSE OF THE INVENTION

The purpose of the invention is to provide a new type of method for producing replicated micro- or nanostructures in film materials having thermoforming properties and a polymeric master film with a surface relief pattern, with which the disadvantages and flaws related to prior art can be significantly reduced. The polymeric master film allows especially large scale mass production

### SUMMARY

The method according to the present invention is characterized by what is presented in claim 1.

The polymeric master film with a surface relief structure/pattern according to the invention is characterized by what has been presented in claim 6.

The use of the master film with a surface relief structure/pattern according to the invention is characterized by what has been presented in claim 15.

The method according to the invention comprises producing micro- or nanostructures in polymer film materials having thermoforming properties in an extrusion process. In the method a molten thermoforming polymer film is provided from an extruder. This molten polymer film is driven through a nip wherein the molten thermoforming polymer film is contacted with a cooling roller supporting a master film with a surface relief pattern and a pressure roller, so that micro- or nanostructures are replicated onto the polymer film by the action of pressure and cooling at the nip. The master film with a surface relief pattern is a polymeric master film and it is driven continuously from the master film feed roller through the nip to the receiver roller.

The master film can also be rewound or fed again through the cooling roller and pressure roller. This enables a continuous process.

The term “replication” should be understood as referring to copying of micro- or nanostructures onto the polymer film having thermoforming properties from a master film with a surface relief pattern by the effect of pressure and cooling.

The term “micro- or nanostructures” should be understood as referring to fine structures such as light scattering/light diffractive optical elements or microcodes etc. Typical examples of fine structures and gratings are: holograms, microlenses, freshnel lenses, antireflection structures, hydrophobic and hydrophilic surfaces, self cleaning surfaces, antimicrobial and microfluidistic structures.

A polymer having thermoforming properties is a polymer which can be heated to a pliable forming temperature, formed to a specific shape and cooled to a finished shape.

Examples of polymer film materials having thermoforming properties are thermoplastics such as polyethylene, or other polyolefin, polyterephthalate or other polyester, or a combination and/or mixture thereof.

The method according to the invention can use sheet/film extrusion, extrusion coating, coextrusion or other extrusion processes and machines suitable for extrusion of polymeric films having thermoforming properties.

In one embodiment of the invention the replication of the micro- or nanostructures onto the polymer film is achieved by pulling the molten polymer film through a nip between the cooling roller supporting the master film and the pressure roller.

In one embodiment of the invention the replication of the micro- or nanostructures onto the polymer film and coating a substrate material is achieved by pulling the molten polymer film and the substrate material through a nip between the cooling roller supporting the master film and the pressure roller. The substrate material can be plastic films, paperboard, corrugated fiberboard, paper, aluminium foils, cellulose, textiles, nonwovens, or other flexible material.

In another embodiment of invention the substrate material can be already coated with the polymer film having micro- or nanostructures replicated onto the surface. The extrusion coating process using already coated substrate material can be used to improve the security, visibility, light transmittance or reflectionproperties of the final product when the nano- or microstructures of the first film layer are protected by the nano- or microstructures of the second extruded film layer.

In one embodiment of the invention the nano- or microstructures of the first film layer of the final product are coated with a high reftractive index coating layer and this coated first film layer is coated with the second extruded layer having nano- or microstructures. The method of the invention does not need high nip pressures and it enables the manufacture of a second or more nano- or microstructures on the top of the first nano- or microstructure.

In one embodiment of the invention the replication of the micro- or nanostructures onto the polymer film is achieved by manufacturing co-extruded films and and pulling the two molten polymer films through a nip between cooling and pressure rollers. This process can be used to apply one or more film layers on the polymer film or one or more film layers on top of a base material in order to obtain specific surface properties.

The nip between the cooling and the pressure rollers determines the film thickness and the polymeric master film supported by the cooling roller determines the surface pattern/structure.

If additional cooling is needed the extruded polymer film can be cooled before it is driven to the nip. The replicated polymer film after the nip can also be cooled with one or more additional cooling rollers.

The replication temperature used in the method according to the invention is 15-350° C., preferably 50-100° C. The temperature depends on the polymeric film material.

The pressure at the nip is normally 0.5-10 bar, preferably 2-6 bar.

The speed of the molten polymer film at the nip in the method according to the invention is 1-400 m/min, preferably 40-100 m/min.

A master film according to the invention with a surface relief pattern for producing micro- or nanostructures in film materials having thermoforming or thermosetting properties is a polymeric master film. The master film comprises a base film.

In one embodiment of the invention the master film comprises a base film and one or more coating layers. The coating layers may be used to improve for example abrasion resistance, release, heat conductivity or adhesive properties of the polymeric master film.

The base film of the master film comprises a thermoplastic and/or thermosetting polymer, such as polyethylene terephthalate PET, polycarbonate PC, polyvinylchloride PVC, glycol-modified polyethylene terephthalate copolyester PETG, polymethylmethacrylate PMMA, cyclo-olefin polymer COP, cyclo-olefin copolymer COC, polyurethane PU, polypropylene PP, polyethylene PE, polystyrene PS, polysulfone PSU, triacetyl cellulose TAC, polymethylpentene PMP, cross-linked polyethylene and/or mixtures thereof.

In one embodiment of the invention the base film consists of 2-6 base layers, preferably 2-3 base layers made by co-extrusion, film extrusion, casting, and/or lamination. The base layers may comprise flexible substrates such as thermoplastic and/or thermosetting polymer, carton, paperboard, paper and metal foil. The thermoplastic and/or thermosetting polymer layer is on the top of the base film.

The thickness of the base film can be in the range of 15-500 μm.

The coating layer enhances the replication of the micro- or nanostructures in the method of the invention. The coating layer comprises fillers, materials increasing heat conductivity, insulators, release agents, lubricants, wetting agents, adhesive materials and/or mixtures thereof. Examples of these filler, heat conductivity increasing, insulator, release, lubricant, wetting and adhesive materials which can also be used in the base film include acrylic, epoxy, urethane-based or standard printing inks or lacquers applied in the printing industry, micro- and nanosized fillers, for example TiO2, ZnO, clay, CaCO3, FeO3, CuO and carbon compounds, and lubricants and release agents, for example silicones, perfluoroether and waxes. The coating layer of the base film can for example be an evaporated or sputtered metallic, semi-conductor, sol-gel coating layer improving abrasion resistance, scratch resistance, releasability, wetting, heat conductivity and insulation. The heat condictivity of the coating speeds up the replication. The material of the base film and/or the material of the top coating layer of the master film is more durable and thermally more resistant than the materials used in the polymer film.

In one embodiment of the invention the polymeric master film comprises a base film, an abrasion resistance coating layer on the surface relief structure/pattern of the base film and an adhesive layer on the bottom surface.

The polymeric master film according to the invention can be manufactured by nanoimprinting techniques, like hot embossing or UV embossing, or by extrusion coating or by an extrusion film system. Micro- and nanostructures are replicated on the polymeric master film using a nanodesigned plate or sleeve, or an embossing roll with nanodesigned engraving straight on the roll surface.

The base film of the polymeric master film can be coated before or after the manufacturing by the replication process.

In one embodiment of the invention the surface relief pattern of the master film is partly masked with a coating layer having predetermined patterns in order to produce extra patterns to the replicated polymer film.

In one embodiment of the invention the surface relief pattern of the master film is equipped with register marks in order to enable the registration with the molten polymer film to be replicated.

The polymeric master film according to the invention can be used for producing micro- or nanostructures in film materials having thermoforming properties by pulling the molten polymer film from the extruder or polymer film or web softened by heat through a nip between the cooling roller supporting the master film and the pressure roller. By the selection of the thermoformable web or film as such or a suitable coating on top of the thermoformable web or film, the polymeric master film may be used to make the replicated micro- or nanostructure straight on the web or film surface.

The polymeric master film according to the invention can be used for producing micro- or nanostructures onto all extrusion coated or wet coated substrates in roll-to-roll production or in sheet-fed production, e.g. plastics, paper, paper board, carton and composites targeted for enhanced product differentiation, decoration, controlled light transmittance and reflection, controlled wetting, adhesion and anti-microbial properties, and security purposes

The method and the master film according to the invention are especially suited for large-scale mass production. The manufacturing and handling of large polymeric master films is easy. The method according to the invention enables continuous use of the master film during extrusion processing. Further, the invention allows lower nip pressures which enhance the life-time of the master film. Furthermore, by the method and the master film according to the invention, a product may be provided with additional patterns or effects representing the authenticity of the product. The method and the manufactured film products are completely harmless to the environment. Also, the polymeric master films according to the invention are affordable in expenses.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 presents a schematic graph of the producing method according to the invention.

FIG. 2 presents another schematic graph of the producing method according to the invention.

FIG. 3 presents the master film according to the invention.

FIG. 4 presents a coated master film according to the invention.

FIG. 5 presents a coated master film according to the invention.

FIG. 6 presents a coated master film according to the invention.

### DETAILED DESCRIPTION OF THE INVENTION

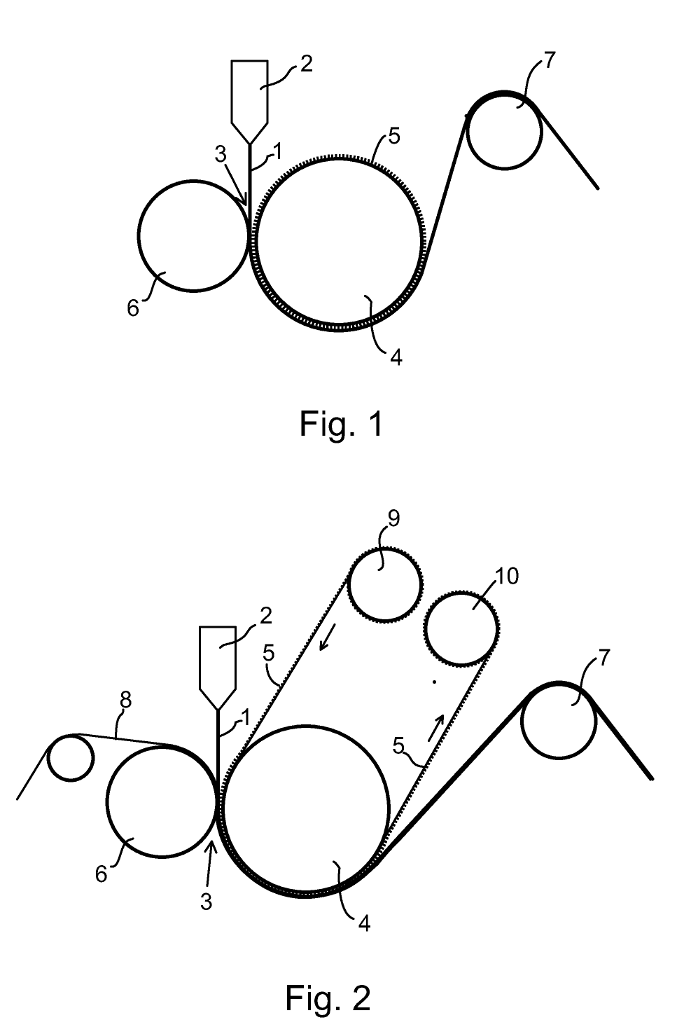

FIG. 1 illustrates a method according to one embodiment of the present invention for producing micro- or nanostructures in polymer film materials having thermoforming properties in a film extrusion process. A molten thermoforming polymer film (1) is provided from the extruder (2). The material of the molten polymer film can be e.g. polyethylene or other polyolefin, polyterephthalate or other polyester, or a combination and/or mixture thereof. The material is advantageously polyolefin e.g. polyethylene. The width of the polymer film can lie in the range of 0.3-5 m, normally 0.6-3 m and the thickness of the film can lie in the range of 6-50 μm. The polymeric master film having a surface relief pattern (5) is assembled around the cooling roller (4). The material of the master film can be thermosetting polymer e.g. polyester and advantageously polycarbonate. The surface relief pattern (5) is an optical fine structure which is hot-embossed on the master film. The master film can comprise one or more coating layers for e.g. protective and/or release purposes. The master film can also comprise one or more adhesive layers e.g. for attaching the master film to the cooling roller. The molten polymer film is conveyed through a nip (3) between the cooling roller and the pressure roller (6), and the optical grating structure is replicated onto the surface of the molten film by the action of pressure and cooling. The replication temperature can lie in the range of 15-350 C, the pressure at the nip can lie in the range of 2-6 bar and the speed of the molten polymer film at the nip can lie in the range of 1-400 m/min. If needed the molten polymer film can be cooled or heated with cooling or heating rollers before entering the nip.

The replicated film having the optical grating structure is transported to one or more guide rollers (7) and possibly wrapped on a storage roller. If needed, the replicated film can be cooled with cooling rollers before transportation to the guide roller.

FIG. 2 illustrates a method according to one embodiment of the present invention for producing micro- or nanostructures in polymer film materials having thermoforming properties in an extrusion coating process. The molten thermoforming polymer film (1) is provided from the extruder (2). The master film (5) supported by the cooling roller (4) can be driven continuously from the master film feed roller (9) through the nip (3) to the receiver roller (10). The master film can also be rewound or fed again through the cooling roller and pressure roller. It is also possible to drive two master film rollers side by side at the same time.

Replication of the micro- or nanostructures onto the polymer film and a coating a substrate material is achieved by pulling the molten polymer film (1) and the substrate material (8) through a nip (3) between the cooling roller (4) supporting the master film and the pressure roller (6). The replication temperature can lie in the range of 15-350 C, the pressure at the nip can lie in the range of 2 -6 bar and the speed of the molten polymer film at the nip can lie in the range of 1-400 m/min. The substrate material (8) can be plastic films, paperboard, corrugated fiberboard, paper, aluminium foils, textiles, nonwovenscellulose, advantageously paperboard.

The replicated film having an optical grating structure is transported to one or more guide rollers (7). If needed, the replicated film can be cooled with cooling rollers before transportation to the guide roller.

The arrangement shown in FIG. 2 enables continuous use of the polymeric master film during extrusion processing.

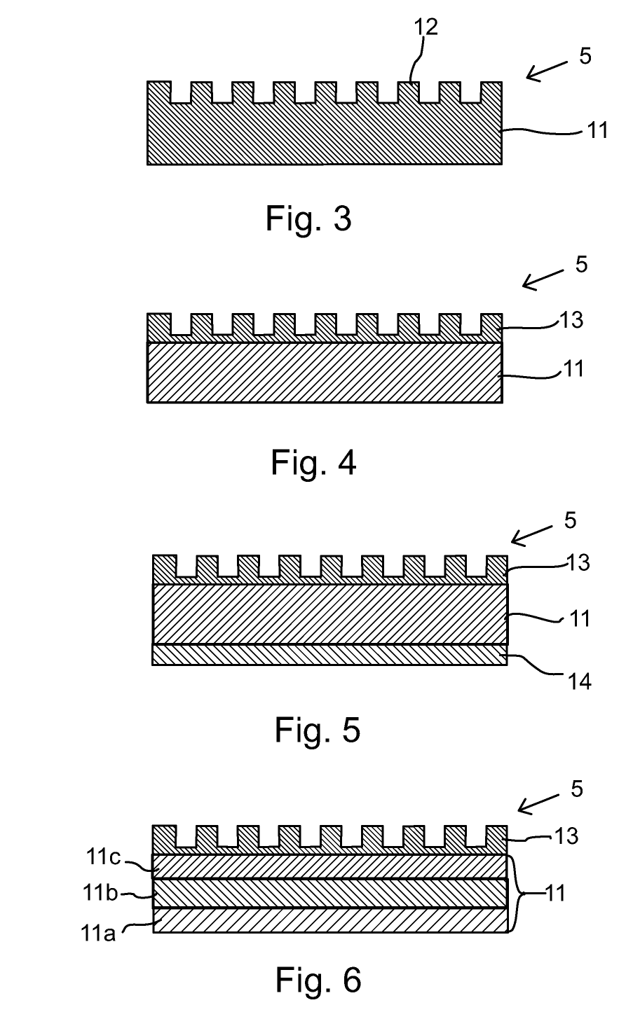

FIG. 3 shows a part of a master film with a surface relief pattern (5) for producing micro- or nanostructures in polymer film materials having thermoforming or thermosetting properties. The master film consists of a base film (11) which is normally a thermoplastic or thermosetting polymer material, e.g. polypropene or other polyolefin, polyterephthalate or other polyester, or a combination and/or mixture thereof. The base film consists of an optical grating structure (12) which has been UV- or hot-embossed on the surface of the base film. The distance of the gratings from each other and the height of the gratings are normally in the range of about 100 to 1000 nanometers, but may also be in the range of a few nanometers.

FIG. 4 shows a part of a master film with a surface relief pattern (5) consisting of a base film (11) and a coating layer (13) coated over the optical grating structure. The coating layer can be used to enhance the abrasion resistance and the release properties of the master film. The materials of the coating layer can for example include fillers such as TiO₂, lubricants and release agents such as silicones, perfluoroether and waxes. The coating layer can also contain heat conductivity materials for speeding up the replication step.

FIG. 5 shows a part of a master film with a surface relief pattern (5) consisting of a base film (11), a coating layer (13) coated over the optical grating structure and an adhesive layer (14) on the bottom of the base film. The adhesive layer can be used to glue the master film on the cooling roller.

FIG. 6 shows a part of a master film with a surface relief pattern (5) consisting of a base film (11) and a coating layer (13) coated over the optical grating structure. The base film (11) consists of 3 base layers (11a-11c). The material of the base layers is flexible material. The material of the base layer (11a) can be e.g. carton and the material of the base layers (11b) and (11c) can be a thermoplastic and a thermosetting polymer e.g polyethylene and polyethylene terephthalate.

### Example 1

Extrusion coating of PE (polyethylene, extrusion coating grade, Borealis CA7230) onto carton board (Ensocoat grammage 190 g/m2).
Parameters used in extrusion coating:
web and die width 400 mm
PE coating weigth 35 g/m2
melting temperature 250-300° C.
cooling roller diameter 600 mm, temperature 15° C.
nip pressure between cooling roller and rubber pressure roller 3.0-5.0 bar
line speed 50, 60, 80 m/min

Master film: 50 micrometer thick polyester film with hot embossed diffractive grating, the distance of gratings from each other and the height of the gratings being 100 to 150 nanometers, coated with high refractive index based polymer coating.

Master film, 1000×200 mm, was taped on chill roll, diffractive grating towards the rubber pressure roller.
Results: diffractive gratings were copied equally well onto PE extruded on the carton board with all used line speeds, melting temperatures and nip pressures.

The invention is not limited merely to the exemplary embodiments referred to above; instead, many variations are possible within the scope of the inventive idea defined by the claims.

1. A method for producing micro- or nanostructures in polymer film materials having thermoforming properties in an extrusion process, the method comprising:
providing a molten thermoforming polymer film from an extruder, driving a molten polymer film through a nip wherein the molten thermoforming polymer film is contacted with a cooling roller supporting a master film with a surface relief pattern and a pressure roller, so that micro- or nanostructures are replicated onto the polymer film by the action of pressure and cooling at the nip, characterized in that the master film with a surface relief pattern is a polymeric master film and wherein it is driven continuously from the master film feed roller through the nip to the receiver roller.

2. The method according to claim 1, wherein the replicated polymer film is coated on a substrate material.

3. The method according to claim 1, wherein the replication temperature is 15-350° C.

4. The method according to claim 1, wherein the pressure at the nip is 0.5-10 bar.

5. The method according to claim 1, wherein the speed of the molten polymer film at the nip is 1-400 m/min.

6. A master film with a surface relief pattern for producing micro- or nanostructures in film materials having thermoforming or thermosetting properties, wherein that the master film is a polymeric master film.

7. The master film according to claim 6, wherein the master film comprises a base film.

8. The master film according to claim 6, comprising one or more coating layers.

9. The master film according to claim 6, wherein the base film comprises a thermoplastic and/or thermosetting polymer.

10. The master film according to claim 6, wherein the base film and/or the coating layer(s) comprise fillers, materials increasing heat conductivity, insulators, release agents, lubricants, wetting agents and/or adhesive materials.

11. The master film according to claim 7, wherein the base film comprises 2-6 base layers, preferably 2-3 base layers.

12. The master film according to claim 11, wherein the base layer comprises flexible substrates such as thermoplastic and/or thermosetting polymer, carton, paperboard, paper and metal foil and the thermoplastic and/or thermosetting polymer layer is on the top of the base film.

13. The master film according to claim 6, wherein the polymeric master film comprises a base film, an abrasion resistance coating layer on a surface relief pattern of the base film and an adhesive layer on the bottom surface.

14. The method according to claim 6, wherein the master film with a surface relief pattern is partly masked.

15. (canceled)

16. The method according to claim 1, wherein the replication temperature is 50-100° C.

17. The method according to claim 1, wherein the pressure at the nip is 2-6 bar.

18. The method according to claim 1, wherein the speed of the molten polymer film at the nip is 40-100 m/min.

19. The master film according to claim 9, wherein the thermoplastic and/or thermosetting polymer is selected from the group of polyethylene terephthalate PET, polycarbonate PC, polyvinylchloride PVC, glycol-modified polyethylene terephthalate copolyester PETG, polymethylmethacrylate PMMA, cyclo-olefin polymer COP, cyclo-olefin copolymer COC, polyurethane PU, polypropylene PP, polyethylene PE, polystyrene PS, polysulfone PSU, triacetyl cellulose TAC, polymethylpentene PMP, cross-linked polyethylene, and a mixture thereof.

20. The master film according to claim 7, wherein the base film comprises 2-3 base layers.

21. The master film according to claim 11, wherein the flexible substrates are selected from the group of thermoplastic and/or thermosetting polymer, carton, paperboard, paper, and metal foil, and wherein the thermoplastic and/or thermosetting polymer layer is on the top of the base film.
